(19) United States
(12) Patent Application Publication
(10) Pub. No.: US 2016/0223826 A1
(43) Pub. Date: Aug. 4, 2016

(54) IMAGE DISPLAY DEVICE

(71) Applicant: KABUSHIKI KAISHA TOSHIBA, Tokyo (JP)

(72) Inventors: Hidefumi TAKAMINE, Tokyo (JP); Shinichi TATSUTA, Tokyo (JP)

(21) Appl. No.: 15/014,588

(22) Filed: Feb. 3, 2016

(30) Foreign Application Priority Data
Feb. 4, 2015 (JP) 2015-020648

(51) Int. Cl. G02B 27/22; G02B 3/00

(52) U.S. Cl. CPC G02B 27/2214; G02B 3/0062; G02B 3/0075

(57) ABSTRACT

According to one embodiment, an image display device includes a first lens member and a second lens member. The first lens member includes a plurality of first cylindrical lenses and a plurality of first projections. The plurality of first cylindrical lenses extend in a first direction and are arranged in a second direction that is perpendicular to the first direction. The plurality of first projections protrude between two adjacent ones of the first cylindrical lenses and extend in the first direction. The second lens member has a same composition as the first lens member, and includes a plurality of second cylindrical lens and a plurality of second projections. The plurality of second cylindrical lens has a same composition as the first cylindrical lenses. The plurality of second projections have a same composition as the first projections. The first lens member and the second lens member are placed on top of each other with each of the first projections inserted between two adjacent ones of the second cylindrical lenses and each of the second projections inserted between two adjacent ones of the first cylindrical lenses. The image display device is configured such that an image is shown through the first lens member and the second lens member.

### CROSS-REFERENCE TO RELATED APPLICATIONS

This application is based upon and claims the benefit of priority from Japanese Patent Application No. 2015-020648, filed on Feb. 4, 2015; the entire contents of which are incorporated herein by reference.

### FIELD

Embodiments described herein relate generally to an image display device.

### BACKGROUND

Conventionally, there has been known an image display device including two lenticular lenses and an element for reducing crosstalk.

It is useful to achieve a novel structure of such an image display device with the lenticular lenses for reducing inconveniency.

### BRIEF DESCRIPTION OF THE DRAWINGS

FIG. 1 is an exemplary side view schematically illustrating a part of an image display device according to a first embodiment;

FIG. 2 is an exemplary side view schematically illustrating a part of an image display device according to a first modification of the first embodiment;

FIG. 3 is an exemplary graph of a corresponding relation between a viewing angle and a light amount in an image display device according to the first embodiment;

FIG. 4 is an exemplary graph of a corresponding relation between the viewing angle and the light amount as a reference in which the projections are removed from the image display device according to the first embodiment;

FIG. 5 is an exemplary exploded perspective view schematically illustrating the image display device according to the first embodiment;

FIG. 6 is an exemplary plan view schematically illustrating a lens assembly and a medium on which an image is drawn and a mark is provided in the image display device according to the first embodiment, when the lens assembly is aligned with the medium;

FIG. 7 is an exemplary plan view schematically illustrating a lens assembly and a medium on which an image is drawn and a mark is provided in the image display device according to the first embodiment, when the lens assembly is misaligned with respect to the medium before the alignment of the lens assembly with the medium;

FIG. 8 is an exemplary side view schematically illustrating the image display device according to the first embodiment, when the lens assembly is aligned with the medium on which the image is drawn and the mark is provided;

FIG. 9 is an exemplary exploded perspective view schematically illustrating an image display device according to a second modification of the first embodiment;

FIG. 10 is an exemplary exploded perspective view schematically illustrating an aligning member and a medium on which an image is drawn and a mark is provided in an image display device according to a third modification of the first embodiment;

FIG. 11 is an exemplary exploded perspective view schematically illustrating an aligning member and a medium on which an image is drawn and a mark is provided in an image display device according to a fourth modification of the first embodiment;

FIG. 12 is an exemplary plan view schematically illustrating a mark provided on a medium on which an image is drawn in an image display device according to a second embodiment;

FIG. 13 is an exemplary plan view of a part of the mark illustrated in FIG. 12 viewed through the lens assembly, with the medium and the lens assembly aligned with respect to each other;

FIG. 14 is an exemplary plan view of the part of the mark illustrated in FIG. 12 viewed through the lens assembly, with the medium and the lens assembly misaligned with respect to each other;

FIG. 15 is an exemplary plan view providing a wider view of the part of the mark illustrated in FIG. 12 viewed through the lens assembly, with the medium and the lens assembly misaligned with respect to each other;

FIG. 16 is an exemplary plan view schematically illustrating a mark provided on a medium on which an image is drawn in an image display device according to a modification of the second embodiment;

FIG. 17 is an exemplary plan view of a part of the mark illustrated in FIG. 16 viewed through the lens assembly, with the medium and the lens assembly aligned with respect to each other;

FIG. 18 is an exemplary plan view of the part of the mark illustrated in FIG. 16 viewed through the lens assembly, with the medium and the lens assembly misaligned with respect to each other; and

FIG. 19 is an exemplary wider plan view the part of the mark illustrated in FIG. 16 viewed through the lens assembly, with the medium and the lens assembly misaligned with respect to each other.

### DETAILED DESCRIPTION

In general, according to one embodiment, an image display device comprises a first lens member and a second lens member. The first lens member includes a plurality of first cylindrical lenses and a plurality of first projections. The plurality of first cylindrical lenses extend in a first direction and are arranged in a second direction that is perpendicular to the first direction. The plurality of first projections protrude between two adjacent ones of the first cylindrical lenses and extend in the first direction. The second lens member has a same composition as the first lens member, and includes a plurality of second cylindrical lens and a plurality of second projections. The plurality of second cylindrical lens has a same composition as the first cylindrical lenses. The plurality of second projections have a same composition as the first projections. The first lens member and the second lens member are placed on top of each other with each of the first projections inserted between two adjacent ones of the second cylindrical lenses and each of the second projections inserted between two adjacent ones of the first cylindrical lenses. The image display device is configured such that an image is shown through the first lens member and the second lens member.

Some exemplary embodiments of the present invention will now be explained. The configuration, the control (technical features), and the actions and the results (effects) achieved by the configuration and the control according to the embodiments below are merely exemplary. The same or like components are included in the embodiments and modifications explained below as examples. Such same or like components are, therefore, assigned with the same or like reference numerals, and redundant explanations thereof are omitted herein.

### First Embodiment

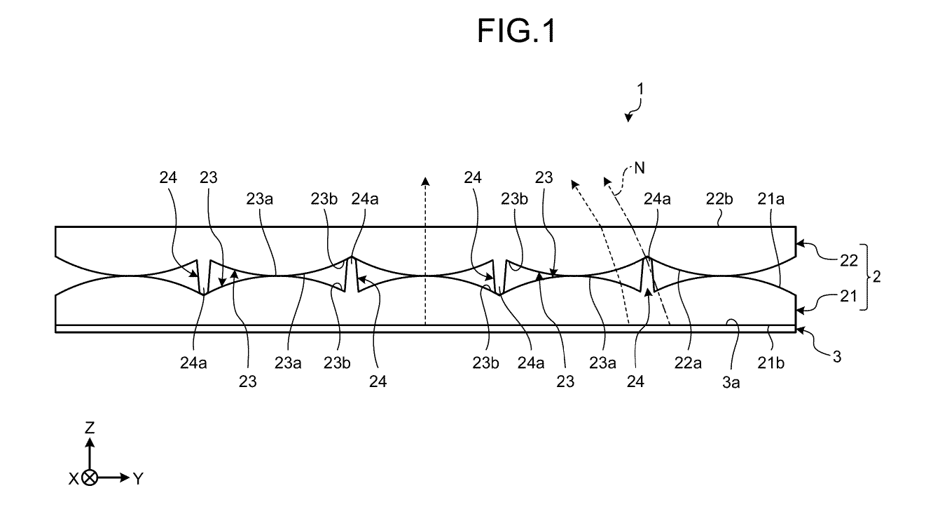

As illustrated in FIG. 1, an image display device 1 according to a first embodiment includes a lens assembly 2 including a plurality of lens members arranged on top of each other in a Z direction, and a medium 3. The Z direction may also be referred to as a thickness direction or a stacking direction. A user looks at an image (not illustrated) on a surface 3a of the medium 3 through the lens assembly 2 from the opposite side of the medium 3. Each of the lens members of the lens assembly 2 is a lenticular lens. Through the lens assembly 2, a user can view a stereoscopic image on the surface 3a processed according to a configuration and characteristics of the lens assembly 2 without wearing any three-dimensional viewing glasses, for example. A working principle and effects of a lenticular lens are known.

The lens assembly 2 according to the embodiment also includes some novel features. That is, the lens assembly 2 includes a plurality of lens members 21 and 22. Each of the lens members 21 and 22 is a lenticular lens. At least two lens members 21 and 22, which are included as a pair, have at least same lens surfaces 21a and 22a and are the same components having the same specifications, for example. Compared with the lens assembly of lens members with different lens surfaces, it is able to reduce manufacturing loads and costs for the lens surfaces 21a and 22a, the lens members 21 and 22, and the lens assembly 2. More specifically, with use of the lens members 21 and 22 made from a transparent synthetic resin material such as plastic by injection molding, for example, the lens members 21 and 22 can be injection-molded with the same mold (mold tool, die), enabling a reduction in the loads and costs required for creating molds. The lens surfaces 21a and 22a can also be referred to as convex or concave-convex surfaces, for example.

The lens member 21 has a plurality of cylindrical lenses 23 extending in an X direction that is perpendicular to the drawing of FIG. 1. Each of the cylindrical lenses 23 has the same or common convex (curved) surface 23a extending in the X direction. The cylindrical lenses 23 are disposed adjacent to each other at a constant interval (first interval, first pitch) in a Y direction perpendicular to or intersecting the X direction. The lens member 21 also has a flat surface 21b opposite the lens surface 21a having the convex surface 23a. The X direction is an example of a first direction and the Y direction is an example of a second direction. The lens member 21 is an example of the first lens member, and the cylindrical lenses 23 of the lens member 21 are an example of a first cylindrical lens.

The lens member 22 is disposed on the opposite side of the medium 3 of the lens member 21. The lens member 22 is the same component as the lens member 21. In other words, the lens member 22 includes a plurality of cylindrical lenses 23 having the same specifications as those of the lens member 21. The lens member 22 also has a lens surface 22a having the same specifications as the lens surface 21a and a surface 22b having the same specifications as the surface 21b. The lens member 22 is an example of a second lens member, and the cylindrical lenses 23 of the lens member 22 are an example of a second cylindrical lens.

The lens members 21 and 22 are integrated with each other, facing opposite directions, that is, in reversed states with respect to each other in the Z direction. The lens members 21 and 22 may be joined by various kinds of joining methods or members. The lens members 21 and 22 are placed on top of each other, with apexes (ridges, generatrixes) of the respective cylindrical lenses 23 abutting on one another.

Each of the lens members 21 and 22 also has a plurality of projections 24, as illustrated in FIG. 1. Each of the projections 24 is positioned in a recess 23b (at a border) between two adjacent cylindrical lenses 23, 23 and protrudes in the protruding direction (Z direction) of the cylindrical lenses 23. Because the lens members 21 and 22 are placed on top of each other with the apexes of the respective cylindrical lenses 23 abutting on each other, as mentioned above, the projections 24 of the lens member 21 protrude into the corresponding recesses 23b on the lens member 22, and the projections 24 of the lens member 22 protrude into the corresponding recesses 23b on the lens member 21. The projections 24 also extend as a wall in the X direction perpendicular to the drawing.

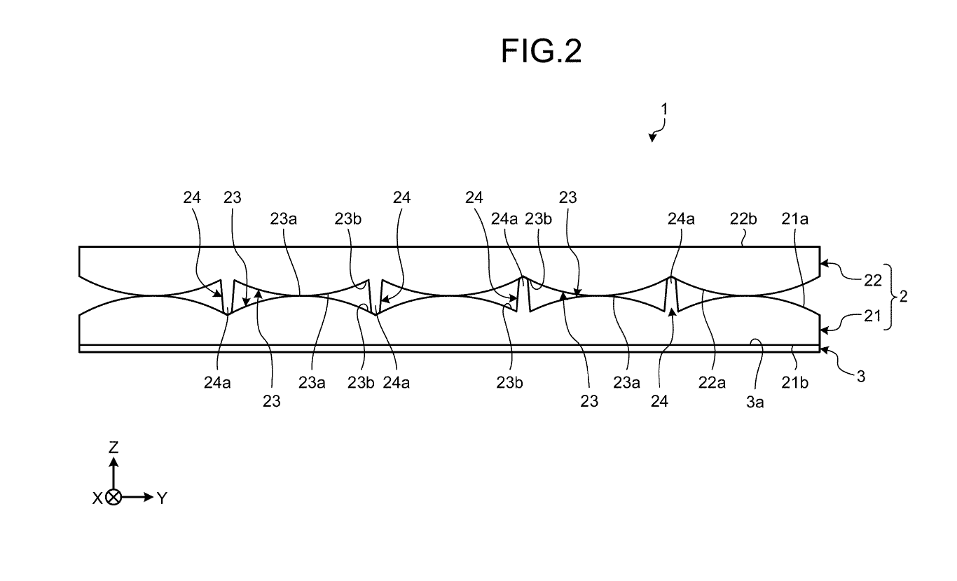

At least the lens surfaces 21a and 22a of the lens members 21 and 22, that is, the portions including the cylindrical lenses 23 and the projections 24 are configured to have the same composition (specifications, shapes, or characteristics), as mentioned above. Therefore, it is necessary for the projections 24 to be arranged not to overlap each other in the Z direction while the lens members 21 and 22 are placed on top of each other with the lens surfaces 21a and 22a facing each other. In view of this, in the example illustrated in FIG. 1, the projections 24 are positioned in every other recess 23b between the two adjacent cylindrical lenses 23 of the lens member 21, and the projections 24 are positioned in every other recess 23b between the two adjacent cylindrical lenses 23 of the lens member 22. Thereby, the lens assembly 2 in which the projections 24 of the lens member 21 and the projections 24 of the lens member 22 are provided alternately in the Y direction can be attained. Arrangements of the projections 24 should not be, however, limited to the arrangements explained above. A constant number n (n≧2, n=2 in FIG. 2) of recesses 23b in which the projections 24 are provided and, and a constant number n of the recesses 23b in which no projections 24 are provided can be arranged in an alternating manner, as illustrated in FIG. 2, corresponding to a first modification of the first embodiment, for example. As another example, the projections 24 can be provided in all of the recesses 23b on one side from the center in the Y direction, although not illustrated. In this manner, the lens members 21 and 22 can be placed on top of each other without the projections 24 of the lens member 21 interfering with the projections 24 of the lens member 22.

As apparent from FIG. 1, tips 24a of the projections 24 of the lens member 21 are inserted into the corresponding recesses 23b of the lens member 22, and the tips 24a of the projections 24 of the lens member 22 are inserted into the corresponding recesses 23b of the lens member 21. The lens members 21 and 22 are configured in such a manner that the ridges of the cylindrical lenses 23 are brought into contact with the ridges of the corresponding cylindrical lenses 23 with minute gaps of more than zero between the tips 24a and the corresponding recesses 23b. The tips 24a each have a curved surface in this example but should not be limited thereto.

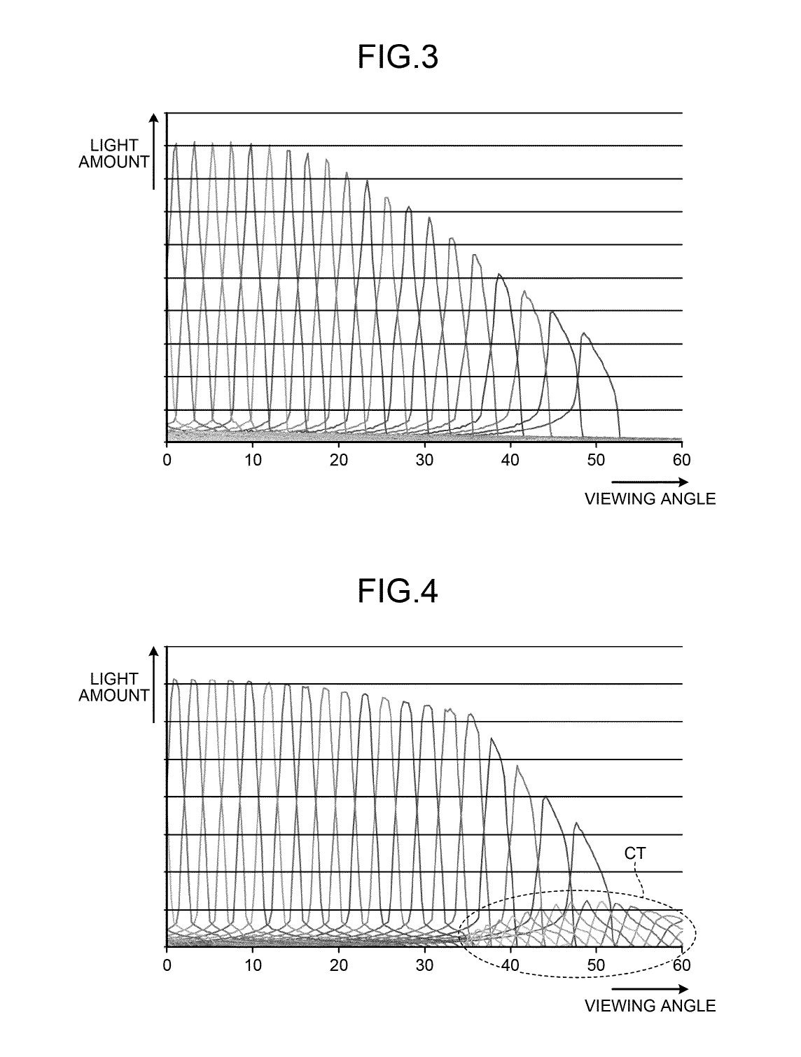

These projections 24 also serve as light shields or light scatters. The light is blocked or scattered by the projections 24. By the projections 24, the light from one of the cylindrical lenses 23 of the lens member 21 can be prevented from being incident on a non-opposing cylindrical lens 23 of the lens member 22 adjacent to the opposing cylindrical lens 23 on which the light is supposed to be incident, and from becoming a noise component (crosstalk), as indicated in the long dashed double-short dashed line N in FIG. 1. FIG. 3 is an exemplary graph of a corresponding relation between a viewing angle (an angle with respect to the Z direction around the X direction) and the light amount in the image display device 1 provided with the projections 24 according to the embodiment. FIG. 4 is an exemplary graph of a corresponding relation between the viewing angle and the light amount in an image display device 1 with no projections for comparison. It can be understood from FIGS. 3 and 4 that noise components CT (crosstalk) are reduced in the embodiment illustrated in FIG. 3 from those in the comparative example illustrated in FIG. 4. The surfaces of the projections 24 may be formed more coarsely than the surfaces of the cylindrical lenses 23. The coarse surfaces of the projections 24 more easily scatter light. To roughen the surfaces of the projections 24, the cavities of the mold of the lens members 21 and 22 corresponding to the projections 24 may be subjected to surface roughening such as sand blast.

In the first embodiment, the projections 24 are also used to align the lens members 21 and 22 in the Y direction. In other words, the tips 24a of the projections 24 from one of the lens members 21 and 22 are inserted into the recesses 23b of the other. Because the tips 24a of the projections 24 hook onto the cylindrical lenses 23 on both sides of the corresponding recesses 23b in the Y direction, Y-directional movements of the lens members 21 and 22 are suppressed, and the recesses 23b of the lens members 21 are ensured to face the recesses 23b of the lens members 22 in the Z direction. Thus, the projections 24 serve as an aligner for the lens members 21 and 22 at least in the Y direction. The projections 24 can also serve as an aligner in the Z-direction. The cylindrical lenses 23 of the lens member 21 may or may not contact with the cylindrical lenses 23 of the lens member 22.

The medium 3 may be directly attached to the lens assembly 2 by adhering or with a coupler, for example, or may be supported or mounted at an aligned position on another member such as a case fixed to or supporting the lens assembly 2. An example of the medium 3 is a sheet of paper on which an image (not illustrated) is printed.

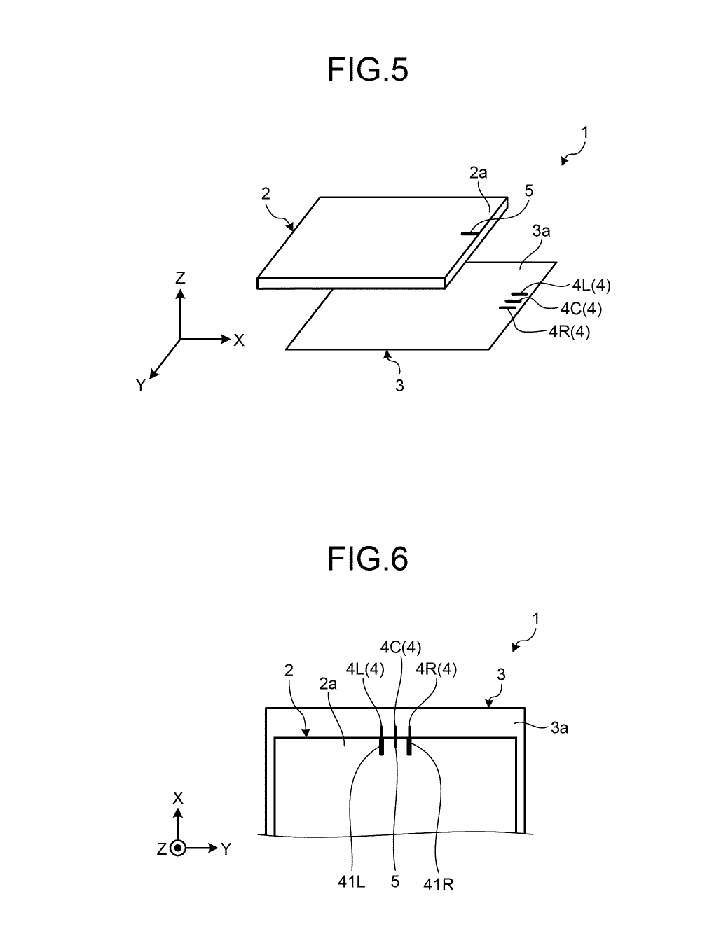

As illustrated in FIGS. 5 and 6, the lens assembly 2 and the medium 3 are provided with marks 4 and 5 for aligning the lens assembly 2 and the medium 3 at least in the Y direction among the X direction and the Y direction. One of the lens assembly 2 and the medium 3 (the medium 3 in the embodiment) is provided with three marks 4 (4L, 4C, and 4R), and the other (the lens assembly 2 in the embodiment) is provided with one mark 5. The marks 4, 5 extend as a strip (segment) in the X direction in which the cylindrical lenses 23 extend. The three marks 4L, 4C, and 4R are provided at an equal interval. The interval of the marks 4L, 4C, and 4R can be appropriately set. For example, the interval of the marks 4L and 4R can be set to substantially coincide with the interval between the two eyes of a person. These marks 4, 5 can be provided on the medium 3 separately from a main image and be covered with a case (not illustrated) of the image display device 1.

In the example illustrated in FIGS. 5 and 6, the lens assembly 2 is aligned with the medium 3 (image) with the center mark 4C of the three marks 4 of the medium 3 placed on the mark 5 of the lens assembly 2 in the Z direction. To begin with, a user places the lens assembly 2 on top of the medium 3 in the Z direction in such a manner that a part (e.g., approximately a half) of the mark 4 on the medium 3 is hidden by an end 2a of the lens assembly 2 and the other part (e.g., approximately a remaining half) is exposed from the end 2a. The user then finds a position where the mark 4C becomes continuous with the mark 5 in the length direction(X direction), as illustrated in FIG. 6, while moving at least one of the lens assembly 2 and the medium 3. The user then fixes the lens assembly 2 and the medium 3 at their aligned positions illustrated in FIG. 6 by attaching the medium 3 to the lens assembly 2 with an adhesive tape or by coupling the medium 3 to the lens assembly 2 with a coupler such as a pin, for example.

FIG. 8 is a side view of the lens assembly 2 and the medium 3 that are aligned with each other. In the embodiment, the marks 4, 5 are designed so that, while the lens assembly 2 and the medium 3 are in alignment with each other as illustrated in FIG. 8, the mark 4C, the recess 23b, and the corresponding projection 24 lie over one another in the Z direction and the marks 4L and 4R lie over the respective apexes of the cylindrical lenses 23 in the Z direction.

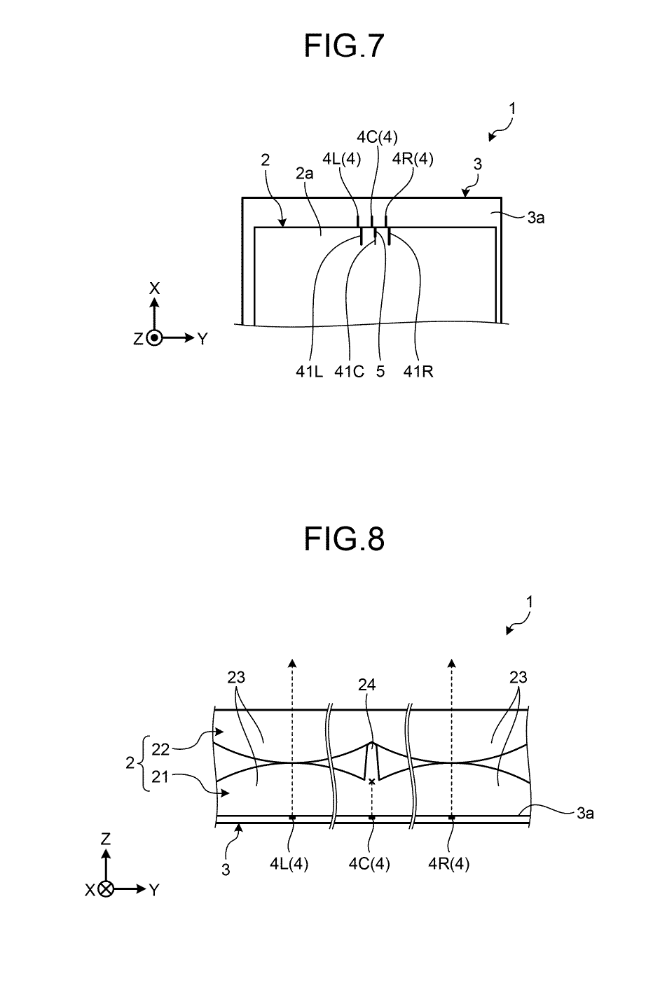

Therefore, at the aligned positions, the widths of images 41L and 41R of the marks 4L and 4R which the user views through the lens assembly 2 are wider than the widths of the marks 4L and 4R which the user directly views without the lens assembly 2, as illustrated in FIG. 6. Further, at the aligned positions an optical path is largely refracted in the recess 23b between the two cylindrical lenses 23 since the mark 4c lies over the recess 23b in the Z direction, so that an image 41C of the mark 4C through the lens assembly 2 becomes invisible (see FIG. 7). However, the part of the mark 4C not hidden behind the end 2a of the lens assembly 2 is linearly aligned with the mark 5 of the lens assembly 2 in the X direction. The cylindrical lenses 23 are an example of a lens unit. The marks 4L and 4R are examples of a first mark and the mark 4C is an example of a second mark.

Meanwhile, the mark 40 may be designed so that at the misaligned positions the image 41C thereof through the lens assembly 2 appears somewhat smaller in width or thinner, for example, as illustrated in FIG. 7, by adjusting a relative position of the mark 40 to the eyes, the width (size) of the mark 4C, and the specifications of the lens assembly 2 appropriately. In FIG. 7, for the sake of better understanding, the misalignment of the lens assembly 2 and the medium 3 is exaggeratingly illustrated from an actual misalignment.

By contrast, at the aligned positions as explained above with reference to FIG. 6, because of the large refraction by the recess 23b, the image of the mark 40 becomes invisible through the lens assembly 2. In other words, according to the embodiment, the mark 4C and the lens assembly 2 can be configured in such a manner that, while the lens assembly 2 and the medium 3 are moved from the misaligned positions in FIG. 7 to the aligned positions in FIG. 6, the visible image 41C of the mark 40 through the lens assembly 2 becomes invisible, that is, the image 41C disappears.

As for the marks 4L and 4R and their images 41L and 41R through the lens assembly 2, while the lens assembly 2 and the medium 3 are moved from the misaligned positions in FIG. 7 to the aligned positions in FIG. 6, the visible marks 41, and 4R not hidden by the lens assembly 2 are moved from the misaligned positions in the Y direction to the linearly aligned positions in the X direction. Therefore, according to the embodiment, the lens assembly 2 and the medium 3 can be more precisely aligned in reference to the marks 4L and 4R and the images 41L and 41R and the mark 5 after generally aligned in reference to the marks 4C and 5, for example.

As explained above, in the embodiment, the parts of the two lens members 21 and 22 (the first lens member and the second lens member) including at least the lens surfaces 21a and 22a, that is, the cylindrical lenses 23 and the projections 24 are designed to have the same composition (specifications) in the lens assembly 2. Therefore, manufacturing loads and costs for the lens assembly 2 can be reduced more easily, compared with, for example, a lens assembly including a combination of lens members with different compositions (specifications). Furthermore, in the embodiment, the projections 24 facilitate the alignment of the two lens members 21 and 22 and function to suppress crosstalk as well. Therefore, the image display device 1 can be simplified in structure and reduced in size, compared with an image display device having separate components for alignment and crosstalk suppression, for example.

Furthermore, in the embodiment, the visually or optically enlarged images 41L and 41R t of the marks 4L and 4R (first mark) through the cylindrical lenses 23 (lens unit) are used to align the lens assembly 2 (lens members 21 and 22) and the medium 3 (the image provided on the medium 3). This can facilitate the alignment and realize more precise alignment, for example.

Furthermore, in the embodiment, the cylindrical lens 23 is used as the lens unit for enlarging the marks 4 for the alignment. Because the cylindrical lens 23 can also be used as the lens unit, the image display device 1 can be further simplified and downsized advantageously, for example, with the one including the cylindrical lens 23 and the lens unit separately.

Furthermore, in the embodiment, the lens assembly 2 (lens members 21 and 22) and the medium 3 (image) become aligned with each other in reference to the marks 4L and 4R and the visually enlarged images 41L and 41R t of the marks 4L and 4R through the lens assembly 2. Therefore, the manufacturing loads and costs for providing the lens assembly 2 with the marks 5 for the alignment can be reduced, as an example.

Furthermore, in the embodiment, the lens assembly 2 (lens members 21 and 22) and the medium 3 (image) become aligned with respect to each other at a position where at least a part of the mark 4C (second mark) becomes invisible, overlapping with the recess 23b (border). By the disappearance of the image 41C of the mark 4C indicating that the lens assembly 2 and the medium 3 are moved from the misaligned positions to the aligned positions, a user can more easily recognize the alignment of the lens assembly 2 and the medium 3, for example. Because the projections 24 (first projections, second projections) are provided in the recesses 23b, the mark 4C may be positioned to overlap with the projection 24.

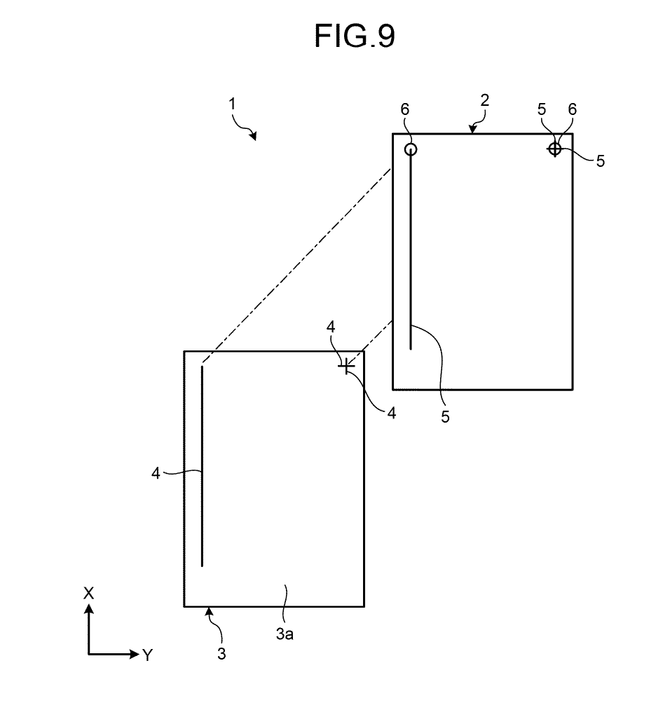

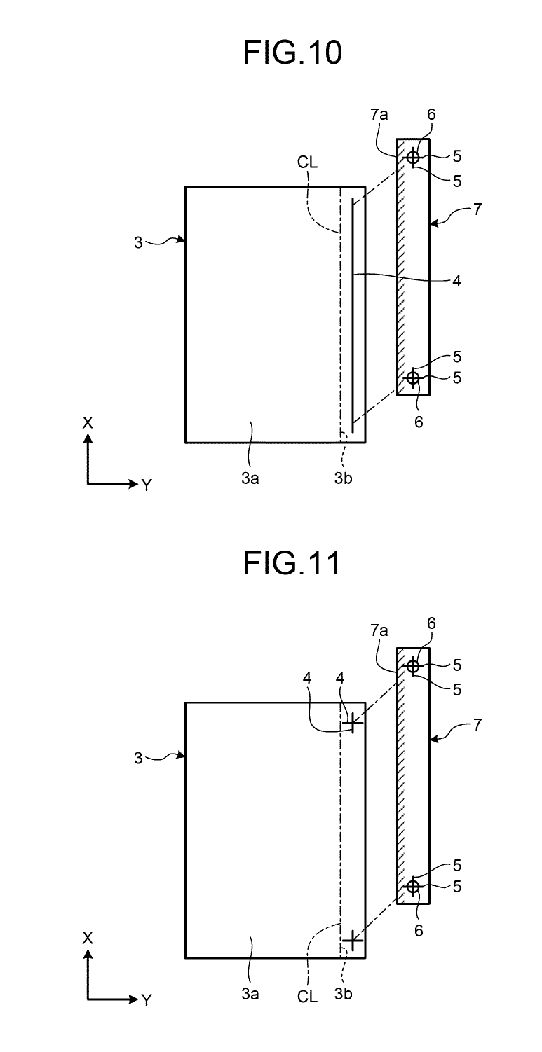

Furthermore, a lens unit 6 for visually enlarging the mark 4 may be provided separately from the cylindrical lens 23, as in the modification illustrated in FIGS. 9 to 11. In the example illustrated in FIG. 9, the lens unit 6 is provided at an end (a corner, a side, or a periphery) of the lens assembly 2 that is separated from the cylindrical lenses 23. In the example illustrated in FIGS. 10 and 11, the lens unit 6 is provided on a different aligning member 7 from the lens assembly 2 (not illustrated in FIGS. 10, 11). In the example illustrated in FIGS. 9 to 11, the lens assembly 2 can be aligned with the medium 3 using the marks 5 and a visually enlarged image (not illustrated), by the lens unit 6, of the mark 4 on the medium 3 for displaying an image (not illustrated). Furthermore, the mark 4 and a visually enlarged image of the mark 4 through the lens unit 6 may be used for the alignment. Furthermore, at least one of the marks 4, 5 may be linear, as illustrated in FIGS. 9 and 10, or may have a cross shape, as illustrated in FIGS. 9 to 11. Furthermore, with the cross-shaped marks 4, 5 or with the marks 4, 5 positioned away from each other in the X direction, the lens assembly 2 can be also aligned with the medium 3 (image) in the X direction. Furthermore, the lens unit 6 and the marks 4, 5 may be covered with a case (not illustrated) of the image display device 1, for example.

Furthermore, in the example illustrated in FIGS. 10 and 11, the lens assembly 2 and the medium 3 (the image on the medium 3) are aligned with respect to each other indirectly via the aligning member 7. Specifically, while the medium 3 and the aligning member 7 are in alignment with each other using the marks 4, 5, the medium 3 is cut along an edge 7a (end) of the aligning member 7 with a cutter (not illustrated), for example. The cutting line CL is indicated by an alternate long and short dash line in FIGS. 10 and 11. In this case, by aligning a cut edge 3b (end) of the medium 3 with an end of the lens assembly 2 (not illustrated) at least in the Y direction, for example, the lens assembly 2 and the image become aligned with each other. Furthermore, for example, by aligning a case (not illustrated) of the image display device 1 with the lens assembly 2 at least in the Y direction and by allowing a wall (not illustrated) of the case to hit the edge 3b in the Y direction, the lens assembly 2 and the image can be aligned at least in the Y direction. In the example illustrated in FIGS. 10 and 11, with no necessity to provide the lens unit 6 in the lens assembly 2, for example, the manufacturing loads and costs for the lens assembly 2 can be reduced, and the lens assembly 2 can be further simplified and downsized.

### Second Embodiment

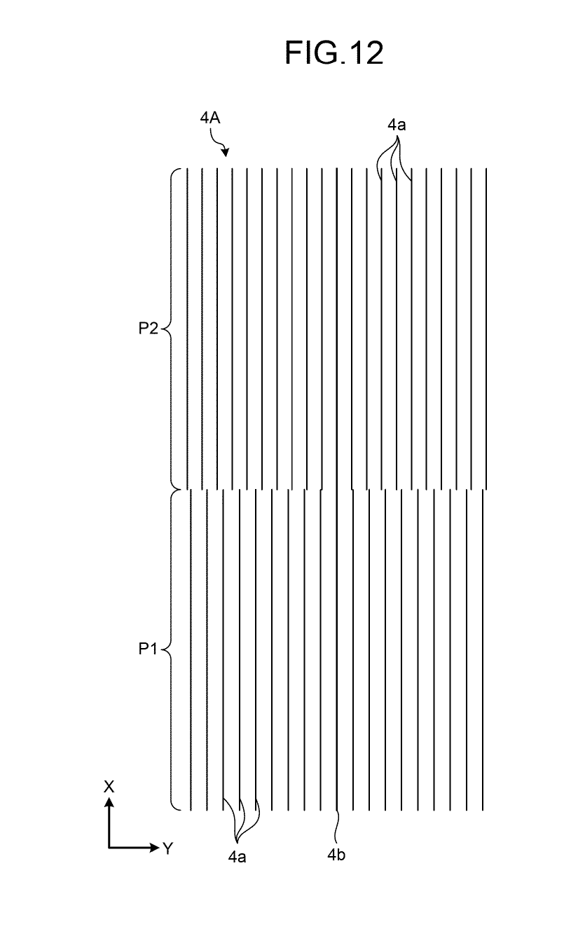

A second embodiment includes the same configuration as that of the first embodiment, therefore, can attain the same effects and results as those of the first embodiment. The mark 4A on the medium 3 according to the second embodiment is, however, differently configured from that according to the first embodiment. Specifically, as illustrated in FIG. 12, the mark 4A includes a plurality of lines 4a arranged with an interval in the Y direction and extending in the X direction. The mark 4A also includes a plurality of patterns P1 and P2 consisting of lines 4a provided at different intervals (pitches). The intervals between the lines 4a in the pattern P1 and in the pattern P2 are slightly different. The pattern P1 is positioned on one side and the pattern P2 is positioned on the other side in the X direction. When “d” denotes the number of dots in an image corresponding to the width of one cylindrical lens 23 in the Y direction, that is, the width of the cylindrical lens 23 in the Y direction, the interval between the lines 4a in the pattern P1 is set to d+m (dots) (where “m” denotes an integer equal to or greater than one), and the interval between the lines 4a in the pattern P2 is set to d-m (dots), for example. In the example illustrated in FIG. 12, a line 4b thicker than the other lines 4a and extending in the X direction is provided at the center in the Y direction. The pattern P1 is an example of a first area and the pattern P2 is an example of a second area. The interval between the lines 4a in the pattern P1 is an example of a first interval and the interval between the lines 4a in the pattern P2 is an example of a second interval. The lines 4a are an example of the mark (first mark). The pattern P1 and the pattern P2 may be provided adjacent to each other as illustrated in FIG. 12 or may be separately provided. Furthermore, only one of the pattern P1 and the pattern P2 can be provided for the alignment.

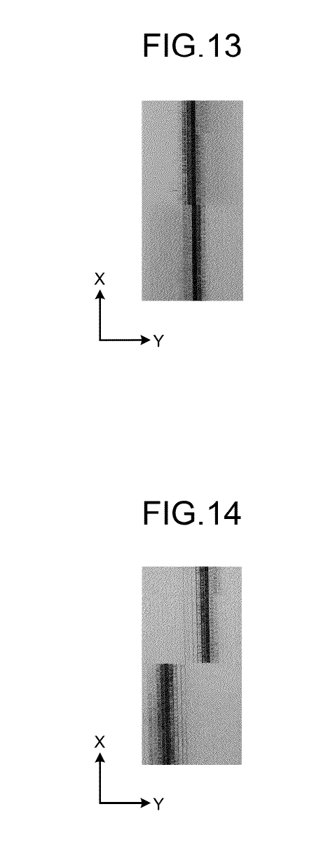

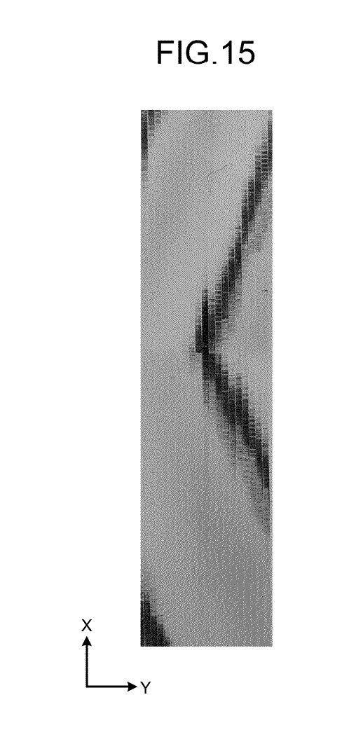

Moire appears in the mark 4A in FIG. 12 when viewed through the lens assembly 2. If the array of the marks 4A is misaligned or tilted with respect to the array of the cylindrical lenses 23 of the lens assembly 2, such moire facilitates a user to visually recognize the misalignment. FIG. 13 illustrates an example in which the mark 4A and the lens assembly 2 are aligned with each other. FIG. 14 illustrates an example in which the mark 4A and the lens assembly 2 are misaligned in the Y direction. FIG. 15 illustrates an example in which the mark 4A and the lens assembly 2 are tilted with respect to each other. It can be understood from FIGS. 13 to 15 that moire appears as a result of using the mark 4A according to the second embodiment, and the mark 4A facilitates a user to recognize the alignment or misalignment of the lens assembly 2 and the medium 3 based on how the moire appears. Note that in FIGS. 14 and 15, the line 4b at the center is hard to recognize. The peripheries of the lens assembly 2 and the medium 3 may also be aligned in reference to the mark 4A. Furthermore, moire may easily viewable if the lines 4a are provided in different colors between the patterns P1 and P2 or if the lines 4a are colored in different colors to set color patterns.

### Modification of Second Embodiment

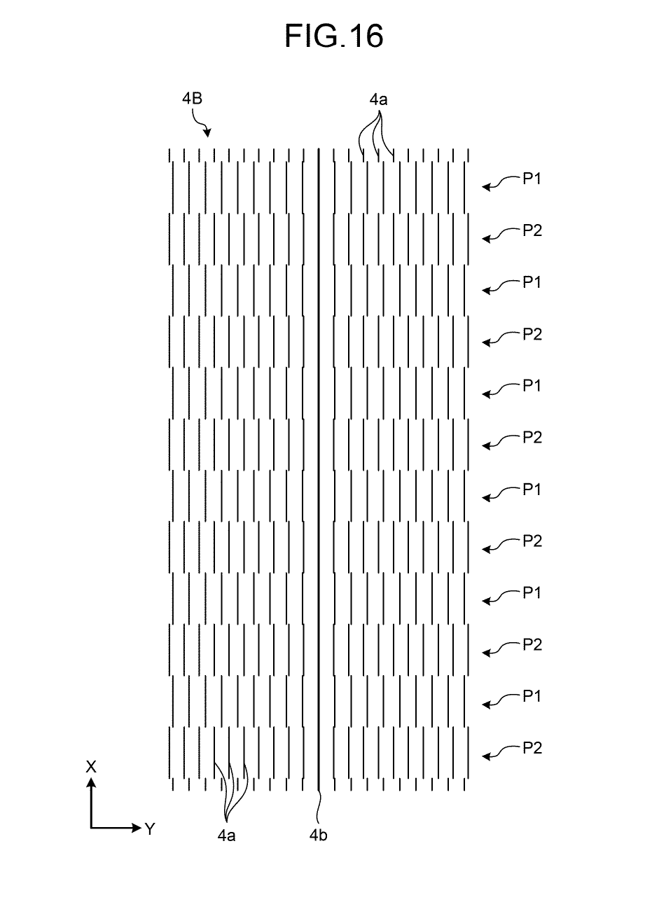

In a modification illustrated in FIG. 16, a mark 4B includes a plurality of lines 4a provided at an interval in the Y direction and extending in parallel in the X direction, as the mark 12A illustrated in FIG. 12. The mark 4B also includes patterns P1 and P2 in which the lines 4a are arranged at different intervals (pitches). The interval between the lines 4a in the pattern P1 is slightly different from that in the pattern P2. In this modification, the pattern P1 and the pattern P2, both of which has the same width (length) in the X direction, are arranged alternately in the X direction. As in the example illustrated in FIG. 1 when “d” denotes the number of dots in the image corresponding to the width of one cylindrical lens 23 in the Y direction, that is, the width of the cylindrical lens 23 in the Y direction, the interval between the lines 4a in the pattern P1 is set to d+m (dots) (where m is an integer equal to or greater than one) and the interval between the lines 4a in the pattern P2 is set to d-m (dots). Furthermore, in this example as well, the line 4b thicker than the other lines 4a and extending in the X direction is provided at the center in the Y direction. The pattern P1 is an example of the first area and the pattern P2 is an example of the second area. The interval between the lines 4a in the pattern P1 is an example of the first interval and the interval between the lines 4a in the pattern P2 is an example of the second interval.

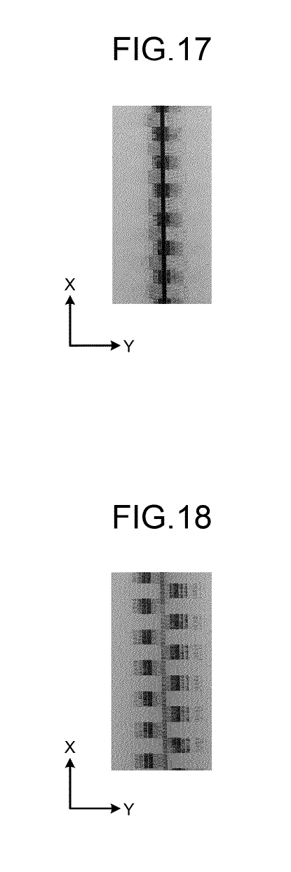

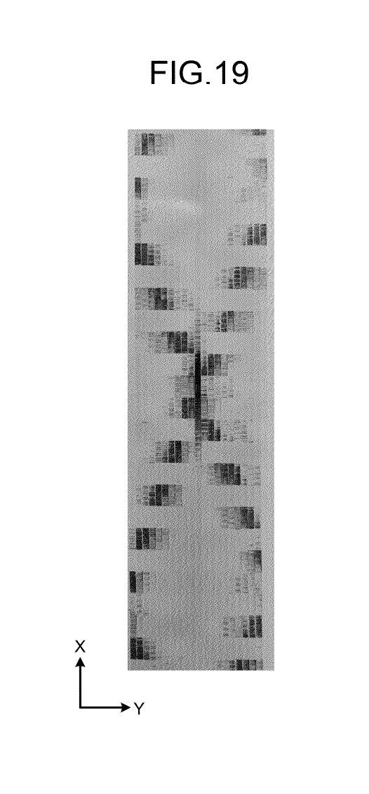

Moire appears in the mark 4B in FIG. 16 when viewed through the lens assembly 2. If the array of the mark 4B is misaligned or tilted with respect to the array of the cylindrical lenses 23 of the lens assembly 2, such moire facilitates a user to visually recognize the misalignment. FIG. 17 illustrates an example in which the mark 4B and the lens assembly 2 are aligned with each other. FIG. 18 illustrates an example in which the mark 45 and the lens assembly 2 are misaligned in the Y direction. FIG. 19 illustrates an example in which the mark 45 and the lens assembly 2 are tilted with respect to each other. It is apparent from FIGS. 17 to 19 that moire appears as a result of using the mark 4B according to the modification, and the mark 4B enables a user to recognize the alignment or misalignment of the lens assembly 2 and the medium 3 more easily based on how the moire appears. Note that in FIGS. 17 and 18, the line 4b at the center is hard to recognize. In this modification as well, the moire may be more viewable if the lines 4a are provided in different colors between the patterns P1 and P2 or if the lines 4a are colored in different colors to set coloring patterns. Furthermore, the modification of the second embodiment illustrated in FIGS. 16 to 19 has the same configuration as that in the first embodiment, therefore, it can attain the same effects or results as those of the first embodiment.

The embodiments and the modifications may also be implemented with some components or shape partly replaced. Furthermore, the embodiments and the modifications may also be implemented with some specifications such as the configurations or the shapes (e.g., structures, types, directions, shapes, sizes, lengths, widths, thicknesses, heights, numbers, arrangements, positions, and materials), modified. For example, specifications of components such as the lens member, the cylindrical lenses, the projections, the marks, and the intervals should not be limited to those disclosed in the embodiments and the modifications. Furthermore, the cylindrical lenses used for the alignment in reference to the marks may be of one of the two lens members. Furthermore, the alignment using the marks should not be limited to the lens assembly and the image (medium) and may be also applied to, for example, two lens members. Furthermore, the lens assembly or the lens members which can be aligned in reference to the marks should not be limited to those disclosed in the embodiment described above. For example, the two lens members of the lens assembly do not need to have the same shape or the lens members do not need to include the projections. The lens assembly may include only one lens member (one lenticular lens). Furthermore, the medium may be made of various types of materials such as paper, film, and a sheet. Furthermore, the medium may be an electric display such as a liquid crystal display (LCD) or an organic electro-luminescent display (OELD), or any other electric display devices such as an electrical scoreboard and a digital signage. Furthermore, the image may be a still image or a moving image.

Furthermore, embodiments may be implemented as specified below.

[1] An image display device comprising:
a medium on which a first mark is disposed at a fixed position with respect to an image; and

a lens member including:
a lenticular lens with a plurality of cylindrical lenses; and
a lens unit, wherein

the image display device is configured such that the image is shown through the lens member, and

a visually enlarged image of the first mark by the lens portion is used for aligning the lens member.

[2] The image display device according to [1], wherein the lens portion is one of the cylindrical lenses.

[3] The image display device according to [1] or [2], further comprising the medium.

What is claimed is:

1. An image display device comprising:
a first lens member including:
a plurality of first cylindrical lenses extending in a first direction and arranged in a second direction that is perpendicular to the first direction; and
a plurality of first projections protruding between two adjacent ones of the first cylindrical lenses and extending in the first direction;
a second lens member having a same composition as the first lens member, and including:
a plurality of second cylindrical lens having a same composition as the first cylindrical lenses; and
a plurality of second projections having a same composition as the first projections, wherein
the first lens member and the second lens member are placed on top of each other with each of the first projections inserted between two adjacent ones of the second cylindrical lenses and each of the second projections inserted between two adjacent ones of the first cylindrical lenses; and
the image display device is configured such that an image is shown through the first lens member and the second lens member.

2. The image display device according to claim 1, wherein
each of the first lens member and the second lens member includes a lens portion, and
a first mark is disposed on a medium on which the image is provided, a position of the first mark is fixed to the image, a visually enlarged image of the first mark by the lens portion is used for aligning the first lens member and the second lens member.

3. The image display device according to claim 2, wherein the lens portion includes at least one of the first cylindrical lens or the second cylindrical lens.

4. The image display device according to claim 2, wherein the image display device is configured such that the first mark and a visually enlarged image of the first mark by the lens portion are used for aligning an assembly and the image, the assembly including the first lens member and the second lens member.

5. The image display device according to claim 3, wherein the first mark includes a plurality of first marks, the plurality of first marks are provided on the medium in the second direction at a second interval, each of the first marks is disposed at a position fixed to the image and has a segment shape extending in the first direction, the second interval is different from a first interval at which the first cylindrical lenses and the second cylindrical lenses are disposed in the second direction.

6. The image display device according to claim 5, wherein the medium includes:
a first area in which the second interval is larger than the first interval; and
a second area in which the second interval is smaller than the first interval.

7. The image display device according to claim 6, wherein the first area includes a plurality of first areas, the second area includes a plurality of second areas, the first areas and the second areas are alternately arranged in the first direction.

8. The image display device according to claim 2, wherein the image display device is configured such that an assembly and the image are arranged at a position, at least a part of the second mark overlaps with the first projection or the second projection at the position, the assembly including the first lens member and the second lens member.

9. The image display device according to claim 2, wherein the image display device is configured such that an assembly of the first lens member and the second lens member and the image are arranged at a position, at least a part of the second mark overlaps with a border between the two adjacent ones of the first cylindrical lenses and a border between the two adjacent ones of the second cylindrical lenses at the position.
